(19) United States
(12) Patent Application Publication
(10) Pub. No.: US 2007/0069523 A1
(43) Pub. Date: Mar. 29, 2007

(54) Cabinet lock installation aid

(76) Inventors: Matthew Richard Alex Nye-Hingston, Auckland (NZ); Neil Richard Hingston, Auckland (AU)

Correspondence Address: JACOBSON HOLMAN PLLC, 400 SEVENTH STREET N.W., SUITE 600, WASHINGTON, DC, 20004, US

(21) Appl. No.: 10/576,271

(22) PCT Filed: Oct. 15, 2004
(86) PCT No.: PCT/NZ04/00252

§ 371 Date: Jul. 17, 2006

(30) Foreign Application Priority Data
Oct. 17, 2003 (NZ) 528985

(51) Int. Cl. E05C 1/02

(52) U.S. Cl. 292/137

(57) ABSTRACT

A lock installation aid to allow as an assembled unit the installation of a lock assembly. The lock assembly is of a kind which includes a housing with which a latch bolt is movable in its axial direction between a locking condition and a retracted into the housing more condition (herein after “unlocked condition”). It also includes a striker having a region with which the bolt can selectively engage to become constrained in a direction transverse to the axial direction. The lock assembly is assembled as a unit by the lock installation aid which comprises an integrally formed body. It has means releasably engagable with the housing and means releasably engagable with the striker to hold the striker relative to the bolt in a manner fixed at least in a direction lateral to the axial direction.

### FIELD OF THE INVENTION

The present invention relates to a lock installation aid and in particular although not solely a lock installation aid and lock set for securing the components of a lock to domestic cabinetry.

### BACKGROUND OF THE INVENTION

Cabinet locks which may for example be of a kind which include a dead bolt locking device and which engages with a striker are reasonably common. Such cabinet locks may lock a door or drawer of a cabinet and may conveniently be electronically actuatable. Electronically actuatable devices of this kind will have a solenoid operated bolt which can move relative to a housing for engagement with and disengagement from a striker. Installation of such cabinet locks may sometimes be required to be performed by home DIY enthusiasts or amateurs. Even if done by professionals installation can be time consuming in order to ensure that the bolt carrying portion of the lock becomes aligned with the striker portion of the lock when the door or drawer of the cabinet is fully closed. Such alignment may be difficult to achieve in order to ensure that a thorough closing of the door or drawer occurs in the position where the bolt is engaged with the striker to lock the cabinet. This is because the striker is mounted normally on the door or drawer movable relative to a frame portion of the cabinet with which the bolt and its housing is engaged. This is also usually on the inside of the cabinet and in an out of the way place. It would accordingly be an advantage to provide a means which allows for convenient installation of a cabinet lock to be provided.

Accordingly it is an object of the present invention to address the abovementioned desiderata or to at least provide the public with a useful choice.

### BRIEF DESCRIPTION OF THE INVENTION

Accordingly, in a first aspect the present invention consists in a lock installation aid to allow as an assembled unit the installation of a lock assembly of a kind which includes (a) a housing with which a latch bolt is movable in its axial direction between a locking condition and a retracted into the housing more condition (herein after “unlocked condition”) and (b) a striker including a region with which the bolt can selectively engage to become constrained in movement relative and in at least a direction transverse to the axial direction therewith, said lock assembly assembled as a unit by said lock installation aid which comprises an integrally formed body defining a means releasably engagable with said housing and a means releasably engagable with said striker to hold said striker relative to said bolt in a manner fixed at least in a direction lateral to said axial direction.

Preferably said installation aid engages to said housing to hold said striker with said housing to present said region of said striker in axial alignment with said bolt as an assembled unit.

Preferably said body includes a means to keep separated said striker in the axial direction from said housing.

Preferably said means to keep separated is a spacer region of said body.

Preferably said means to keep separated is a washer shaped means formed as part of said body.

Preferably said means releasably engagable with said housing is a means rotational with said housing.

Preferably said means releasably engagable with said housing is a bayonet fitting projection, said housing including complimentary shaped receiving regions for said bayonet fitting projection.

Preferably said means releasably engagable with said housing includes an aperture to allow said bolt to extend into said aperture.

Preferably said means releasably engagable with said striker is a cylindrical member.

Preferably said means releasably engagable with said striker is a cylindrical member and said striker provides its said region as an aperture into which said cylindrical member is engaged.

Preferably said means releasably engagable with said striker is a pin and said striker provides its said region as an aperture into which said pin is engaged.

Preferably said region of said striker is provided on a striker plate portion of said striker.

Preferably said striker also includes a mounting member, disposed from said striker plate in a manner to allow it to be mounted to a fixture.

In a further aspect the present invention consists in a lock set comprising

a. a housing with which latch a bolt is movable in its axial direction between a locking condition and a retracted into the housing more condition (herein after “unlocked condition”) and

b. a striker including a region with which the bolt can selectively engage to become constrained in movement relative and in at least a direction transverse to said axial direction therewith,

wherein said striker and said housing are assembled as a unit by a lock installation aid which comprises an integrally formed body defining a means releasably engageable with said housing and a means releasably engageable with said striker to hold said striker relative to said bolt in a manner fixed at least in a direction lateral to said axial direction.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

A preferred form of the present invention will now be described with reference to the accompanying drawings in which:

FIG. 1 is a perspective view of part of a cabinet illustrating in part the cabinet lock engaged with a drawer and fixed structure of a cabinet and wherein the cabinet is in a closed condition,

FIG. 2 is a perspective view according to FIG. 1 but wherein the door or drawer is in a partially opened condition,

FIG. 3-6 illustrate components of the cabinet lock and means for aiding installation in different modes of assembly.

### DETAILED DESCRIPTION OF THE INVENTION

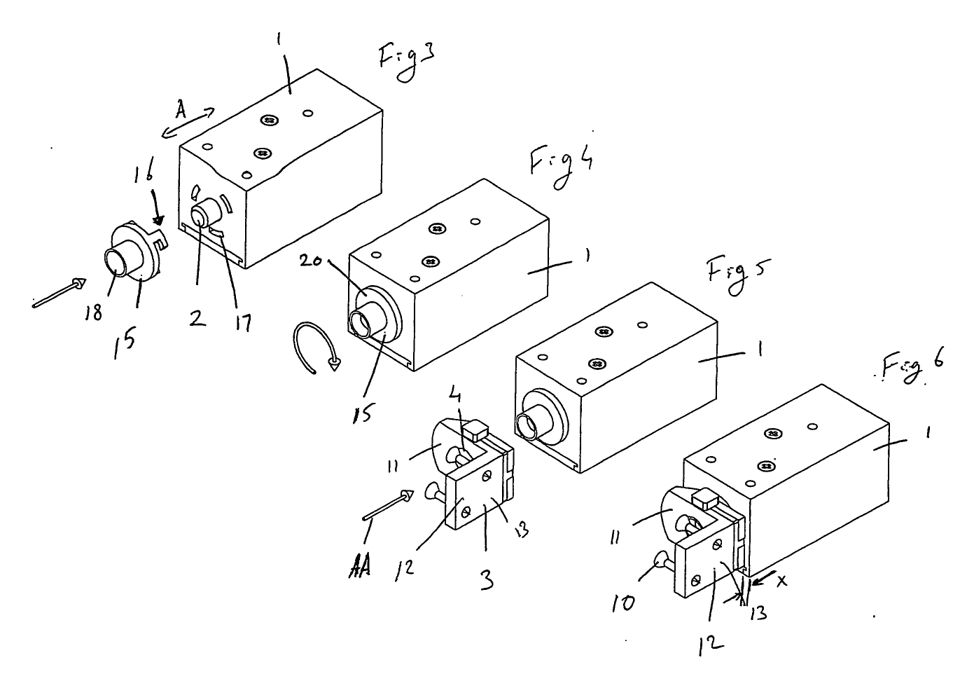

With reference to FIG. 6 there is shown as an assembled unit, a cabinet lock of the present invention assembled with an installation aid. The cabinet lock itself consists of a housing 1 with which there is disposed in a movable configuration a bolt 2. The bolt 2 can move relative to the housing in its axial direction parallel to direction A as shown in FIG. 3. The bolt is preferably at least in part of an elongate configuration. Contained within the housing is a solenoid like arrangement to actuate the bolt in its movement from a locking condition to an unlocked condition and vice versa. In the locking condition the bolt extends more from the housing 1 than in the unlocked condition. The bolt 2 is capable of being engageable with a striker 3 which for example includes an aperture 4 into which the bolt can extend when in the locked condition.

Electronic or electrical energisation of the solenoid can cause the bolt to move either to the locked condition from its unlocked condition and/or from its locked condition to it unlocked condition. Within the housing there may also be provided a means to bias the bolt in one direction or another relative to the housing to encourage in its natural state, the movement of the bolt towards the unlocked condition or towards its locked condition. Such biasing means may for example be a coil spring and in the preferred form encourages the bolt 2 to be biased towards the locked condition.

Energisation of the coil or solenoid within the housing by an electrical energy source encourages the bolt to move from the locked condition to the unlocked condition thereby disengaging it from the striker 3.

The striker 3 includes an aperture 4 which provides a region for retention of the striker 3 relative to the bolt 2 in an direction at least transverse to the axial direction of travel of the bolt parallel to direction A. With the bolt penetrating into the aperture 4 when in the locked condition the striker 3 cannot move in a direction lateral to this axial direction.

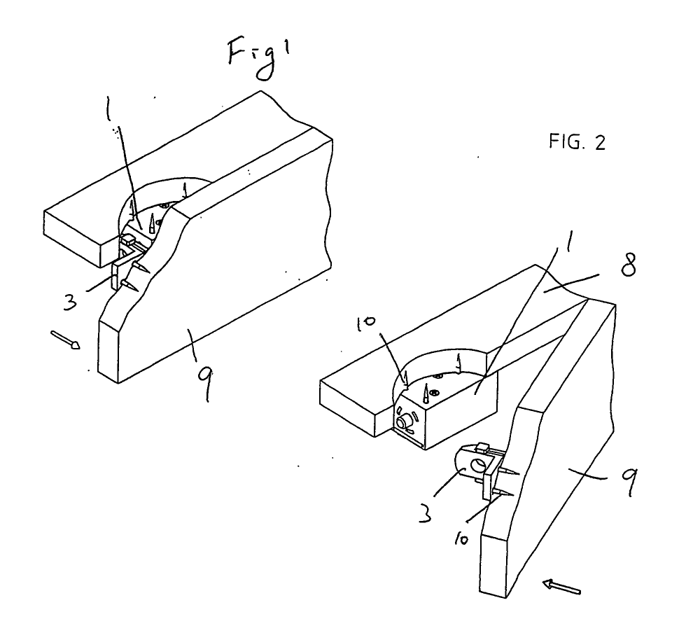

The housing 1 is preferably engaged to one part of a cabinet whereas the striker 3 is engaged to another part movable relative to the first mentioned part of the cabinet and is for example attached to a door or drawer. In an alternative configuration the housing 1 may itself be engaged to a door or drawer whereas the striker is engaged to a fixed structural part of the cabinet. With reference to FIGS. 1 and 2, the housing 1 is engaged to a shelf 8 and the striker 3 is engaged to a door 9 of the cabinet. Fixing is preferably by means of suitable fastening elements such as for example screws 10. The striker 3 itself includes a striker plate 11 through which the aperture 4 is provided. The striker plate may for example be of a kind which presents the aperture lateral through the plate like nature of the striker plate 11. However the striker plate itself may not be of plate like configuration and may be of a more solid configuration.

Furthermore the aperture 4 may not necessarily be an enclosed aperture but may be a rebate in from an edge of the striker plate 11. The striker 3 also includes a mounting region 12 which in the preferred form as shown in FIGS. 5 and 6 extends to present a surface 13 substantially perpendicular to the surface of the striker plate 11 facing the housing 1 (when in the locked configuration as shown in FIG. 1). Such angular disposition of the surface 13 relative to the striker plate 11 is purely dependent on the configuration of the cabinet affixing regions with which the cabinet lock is to engage. It may be that the mounting portion 12 of the striker 3 extends parallel with the striker plate 11. The mounting portion 12 includes apertures through which the fasteners 10 can extend to allow for the striker plate to engage to a part of the cabinet such as for example a drawer 9 or door.

In order to allow for the striker to be positioned in an appropriate location relative to the housing 1, during the affixing of the cabinet lock with the cabinet components, the striker 3 and housing 1 are assembled as a single unit assembly. When the housing and striker are assembled as for example shown in FIG. 6, the striker 3 is secured with the housing 1 in a manner such that the aperture 4 is aligned with the bolt 2 to (when the affixing of the components of the cabinet lock has occurred) allow for the bolt to extend into the aperture 4 of the striker. To allow for the striker 3 to be held in a suitable disposition from and relative to the housing 1 for the installation steps (where at least the striker is to be affixed to part of the cabinet and e.g. where the housing 1 has already been affixed to the cabinet or is also be affixed to the cabinet) a lock installation aid 15 is provided. The lock installation aid 15 is interposed between the striker 3 and the housing 1 and in a manner to allow for it to be engaged with the housing 1 and with the striker 3 to secure the relative disposition of the housing 1 and striker 3. The holding of the striker 3 relative to the housing 1 is at least in a direction transverse to the axial direction of movement of the bolt 2 parallel to direction A. A movement of the striker 3 in direction A may be permitted by the installation aid. The installation aid includes a means to fasten to the housing 1 which may consist of a bayonet fitting 16 which can locate into bayonet receiving apertures 17 of the housing 1. The installation aid may have its bayonet fittings inserted into the apertures 17 and subsequently a rotation of the installation aid will lock the installation aid 15 to the housing 3. The installation aid is then prevented from movement in an axial direction parallel to direction A relative to the housing 1. Also provided by the installation aid is a means to engage with the striker. Such a means to engage may be a pin 18 such as for example the cylindrical pin as shown in FIGS. 3-5. The cylindrical pin is of a size to allow it to be engaged with the region of engagement with which the bolt 2 can engage of the striker 3. In the most preferred form the pin 18 inserts into the aperture 4 of the striker 3. It is a sliding engagement that establishes the connection between the installation aid and the striker 3 such sliding being in direction AA as shown in FIG. 5. Once such sliding engagement has occurred the striker 3 is unable to move in a direction transverse to the direction A. This then holds the striker 3 in a relationship with the housing 1 in a manner such that the bolt is aligned with the aperture 4 of the striker. In the most preferred form the pin 18 is coaxial with the axial direction of the bolt 2 however in any alternative configuration the installation aid may engage with other portions of the striker in a manner such that the aperture 4 of the striker is in alignment with the bolt 2. However in the preferred form the pin 18 mimics the nature of the bolt 2 and extends into the aperture 4 for alignment of the striker with the housing. When the assembled configuration as shown in FIG. 6 has been achieved the assembly can be conveniently handled for the securement of the components of the cabinet lock to the appropriate components of the cabinet. Engagement of the cabinet lock components to the cabinet will then ensure that the housing 1 is positioned in a direction lateral to the axial direction sufficiently close to the surface against which the striker 3 is to be mounted (e.g. the inner face of a door 9). This ensures the fastening surface 13 of the striker is engaged with such an inner surface of the door. The aperture 4 is presented when the door is in the closed condition, to allow it to reach and be in axial alignment with the bolt 2. Likewise the assembled condition of the cabinet lock ensures that the striker 3 is engaged with the inner face of the door at a height corresponding to that at which the housing 1 is affixed to the shelf 8 of the cabinet. Simultaneous and mutual relative disposition of the housing 1 and the striker 3 in the axial direction by the holding of the striker proximate to the housing 1 will ensure that the aperture is presented to be within reach of the bolt when in its fully extended or at least when it is in its locking condition configuration. With reference to the geometry as shown in FIG. 2 such alignment will ensure that in the horizontal direction the striker is proximate to the housing 1. The installation aid may also include a spacer element 20 which is for example of a washer like shape which spaces the surface of the striker plate 11 facing the housing 1 at a distance X from the housing 1. Such a distance X is sufficient to allow for the striker plate to not interfere with the housing itself yet still be presented proximate enough to the bolt so that the bolt in its extended condition can engage with the aperture 4.

1. A lock installation aid to allow as an assembled unit the installation of a lock assembly of a kind which includes (a) a housing with which a latch bolt is movable in its axial direction between a locking condition and a retracted into the housing more condition (herein after “unlocked condition”) and (b) a striker including a region with which the bolt can selectively engage to become constrained in movement relative and in at least a direction transverse to the axial direction therewith, said lock assembly assembled as a unit by said lock installation aid which comprises an integrally formed body defining a means releasably engagable with said housing and a means releasably engagable with said striker to hold said striker relative to said bolt in a manner fixed at least in a direction lateral to said axial direction.

2. The lock installation aid as claimed in claim 1 wherein said installation aid engages to said housing to hold said striker with said housing to present said region of said striker in axial alignment with said bolt as an assembled unit.

3. The lock installation aid as claimed in claim 1 wherein said body includes a means to keep separated said striker in the axial direction from said housing.

4. The lock installation aid as claimed in claim 3 wherein said means to keep separated is a spacer region of said body.

5. The lock installation aid as claimed in claim 3 wherein said means to keep separated is a washer shaped means formed as part of said body.

6. The lock installation aid as claimed in claim 1 wherein said means releasably engagable with said housing is a means rotational with said housing.

7. The lock installation aid as claimed in claim 1 wherein said means releasably engagable with said housing is a bayonet fitting projection, said housing including complimentary shaped receiving regions for said bayonet fitting projection.

8. The lock installation aid as claimed in claim 1 wherein said means releasably engagable with said housing includes an aperture to allow said bolt to extend into said aperture.

9. The lock installation aid as claimed in claim 1 wherein said means releasably engagable with said striker is a cylindrical member.

10. The lock installation aid as claimed in claim 1 wherein said means releasably engagable with said striker is a cylindrical member and said striker provides its said region as an aperture into which said cylindrical member is engaged.

11. The lock installation aid as claimed in claim 1 wherein said means releasably engagable with said striker is a pin and said striker provides its said region as an aperture into which said pin is engaged.

12. The lock installation aid as claimed in claim 11 wherein said region of said striker is provided on a striker plate portion of said striker.

13. The lock installation aid as claimed in claim 1 wherein said striker also includes a mounting member, disposed from said striker plate in a manner to allow it to be mounted to a fixture.

14. A lock set comprising
a. a housing with which latch a bolt is movable in its axial direction between a locking condition and a retracted into the housing more condition (herein after “unlocked condition”) and
b. a striker including a region with which the bolt can selectively engage to become constrained in movement relative and in at least a direction transverse to said axial direction therewith,
wherein said striker and said housing are assembled as a unit by a lock installation aid which comprises an integrally formed body defining a means releasably engageable with said housing and a means releasably engageable with said striker to hold said striker relative to said bolt in a manner fixed at least in a direction lateral to said axial direction.
